(19) United States
(12) Patent Application Publication
(10) Pub. No.: US 2016/0179855 A1
(43) Pub. Date: Jun. 23, 2016

(54) UBIQUITOUS CONTENT ACCESS AND MANAGEMENT

(71) Applicant: YAHOO! INC., Sunnyvale, CA (US)

(72) Inventors: Manuel Roman, Sunnyvale, CA (US); Ric Allinson, Sunnyvale, CA (US); Yujun Qian, Beijing (CN)

(21) Appl. No.: 14/580,614

(22) Filed: Dec. 23, 2014

(51) Int. Cl. G06F 17/30; H04L 29/06

(52) U.S. Cl. CPC G06F 17/30321; H04L 67/42; H04L 63/08

(57) ABSTRACT

Automated centralized access to and management of content items stored on a plurality of content sources is provided. A content services module receives information regarding content sources which comprise third-party cloud storage servers and a user's personal computing devices in addition to receiving the user's access tokens for secured content sources. The content services modules act as a proxy for the user to the content sources and enables the user to execute various tasks across the content items stored in the various content sources via the interface.

### BACKGROUND

With the evolution of mobile data networks, various online and offline content sources and content storing devices are available to users. Different types of content items such as text, audio, video or combinations thereof are provided to the users via various modalities such as webpages, emails, instant messages, chat room conversations, blogs and the like at their various personal computing devices. Such devices not only comprise mobile devices like tablet devices and smartphones but also include wearable devices such as eye glasses or smart watches. As the quality of virtual content exchanged via these devices increases so does its size. While considerable storage is available on personal computing devices, in certain use cases they fail to provide adequate storage for the volume of content that a user exchanges every day via various modalities. Third-party storage services have emerged that offer users a certain amount of content storage space for them to store and share their content.

### SUMMARY

This disclosure relates to automated systems and methods for providing a service that enables users ubiquitous central access and management of content items stored in disparate content storage sources. The method comprises, receiving, by a processor, a request from a first user to connect to a plurality of personal devices having stored thereon a plurality of local content items and to a plurality of third-party cloud storage services having stored thereon a plurality of third-party cloud storage content items. In some embodiments, the processor employs the first user's credentials and proxies as the first user connect to the third-party cloud storage services. The metadata of third-party cloud storage content items stored on the third-party cloud storage service is obtained and stored, for example, on a local storage by the processor. In some embodiments, the local storage can be within the same apparatus as the processor. In some embodiments, the local storage can be in a different apparatus remote from the processor. In either case, the processor will generally have access to read, write to or edit data on the local storage. The processor further provides to the first user a user interface on a selected personal computing device that interfaces with the processor. The processor via user interaction with the user interface and via the metadata, enables access to the plurality of local content items and the plurality of third-party cloud storage content items. In some embodiments, the metadata of each of the third-party cloud storage content items comprises a key-value pair, the key comprising the first user's GUID (Globally Unique ID) and an originalID uniquely identifying the third-party cloud storage content item. The value in the key-value pair comprises the metadata of the content item.

In some embodiments, the method further comprises, providing, by the processor, a user interface element that enables the first user to share at least one of the local content items and the third-party cloud storage content items and receiving, by the processor, a request from the first user to share a third-party cloud storage content item stored with one of the third-party cloud storage services with at least one second user. In some embodiments, the method of enabling sharing one of the third-party cloud storage content items further comprises generating a key-value pair is generated by the processor for the second user. The key of the key-value pair of the second user further comprises the second user's GUID and an originalID uniquely identifying the shared third-party cloud storage content item and the value in the key-value pair of the second user comprises the metadata of the content item that further comprises ownership information associated with the first user.

In some embodiment, the method further comprises receiving, by the processor, request to access at least one of the third-party cloud storage content items. In response to the request, the processor further accesses metadata of the at least one third-party cloud storage content item. The at least one third-party cloud storage content item is downloaded by the processor from a respective third-party cloud storage server and streamed to the user.

In some embodiments, the method of providing centralized management of content items further comprises, downloading and storing, by the processor from respective third-party cloud storage servers, a plurality of the third-party cloud storage content items. When at least one tag is received for commonly applying to each of the plurality of the cloud storage content items, the at least one tag is stored with respective metadata of each of the plurality of the cloud storage content items.

A computing device comprising a processor and a storage medium for tangibly storing thereon program logic for execution by the processor is disclosed in some embodiments. The programming logic comprises request receiving logic, executed by the processor, for receiving a request from a first user to connect to a plurality of personal devices having stored thereon a plurality of local content items and to a plurality of third-party cloud storage services having stored thereon a plurality of third-party cloud storage content items. Connecting logic, is executed by the processor, for connecting to the third-party cloud storage services using the credentials. Metadata of third-party cloud storage content items stored on the third-party cloud storage services is obtained by the metadata obtaining logic executed by the processor. Metadata storing logic is executed by the processor, for storing the metadata on a processor readable storage medium and interface providing logic, is executed by the processor, for providing to the first user a user interface on a selected personal computing device that interfaces with the processor. The processor via user interaction with the user interface and via the metadata, enables access to local content items on the personal devices and the third-party cloud storage content items stored on the plurality content sources to the first user. In some embodiments, the metadata of each of the third-party cloud storage content items comprises a key-value pair, the key comprising the first user's GUID (Globally Unique ID) and an originalID uniquely identifying the third-party cloud storage content item and the value in the key-value pair comprises the metadata of the content item.

In some embodiment, the interface providing logic further comprises logic for providing a user interface element that enables the first user to share at least one of the local content items and the third-party cloud storage content items and for receiving a request from the first user to share a third-party cloud storage content item stored with one of the third-party cloud storage services with at least one second user. The programming logic for enabling sharing one of the third-party cloud storage content items further comprises programming logic for generating, by the processor, a key-value pair for the second user, the key of the key-value pair of the second user further comprising the second user's GUID and an originalID uniquely identifying the shared third-party cloud storage content item and the value in the key-value pair of the second user comprises the metadata of the content item that further comprises ownership information associated with the first user.

In some embodiments, the apparatus further comprises programming logic for downloading from respective third-party cloud storage servers, a plurality of the third-party cloud storage content items and for storing copies the plurality of the cloud storage content items. The apparatus further comprises programming logic for receiving at least one tag for commonly applying to each of the plurality of the cloud storage content items and for storing the at least one tag with respective metadata of each of the plurality of the cloud storage content items.

A computer readable storage medium comprising processor-executable instructions is disclosed in an embodiment. The processor-executable instructions include instructions for receiving a request from a first user to connect to a plurality of personal devices having stored thereon a plurality of local content items and to a plurality of third-party cloud storage services having stored thereon a plurality of third-party cloud storage content items. The medium further comprises instructions for connecting by the processor via a network, to the third-party cloud storage services using the credentials and obtaining metadata of third-party cloud storage content items stored on the third-party cloud storage services. The instructions further include instructions for storing the metadata to a local storage and for providing to the first user, a user interface on a selected personal computing device that interfaces with the processor. The processor via user interaction with the user interface and via the metadata, enables access to the plurality of local content items and the plurality of third-party cloud storage content items. In some embodiments, the metadata of each of the third-party cloud storage content items comprises a key-value pair, the key comprising the first user's GUID (Globally Unique ID) and an originalID uniquely identifying the third-party cloud storage content item and the value in the key-value pair comprises the metadata of the content item.

These and other embodiments/will be apparent to those of ordinary skill in the art with reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a schematic diagram of a system that provides centralized, ubiquitous content access and management to users in accordance with some embodiments;

FIG. 2 illustrates a detailed block diagram of the content services module in accordance with some embodiments;

FIG. 3 is a flowchart that illustrates a method of accessing content stored on a plurality of content sources in accordance with some embodiments;

FIG. 4 is a flowchart that details a method of enabling a user to share content items stored in a third-partly cloud storage in accordance with some embodiments;

FIG. 5 is a flowchart that details a method of providing a shared content item in accordance with some embodiments;

FIG. 6 is a flowchart that details a method of tagging content items stored in different content sources in accordance with some embodiments;

FIG. 7 is a flowchart that details a method of searching for content items across a plurality of content sources in accordance with some embodiments;

FIG. 8A shows a schematic diagram of a cover page of the content access and management user interface in accordance with some embodiments;

FIG. 8B is a schematic diagram of a sidebar that is part of the content access and management user interface in accordance with some embodiments;

FIG. 9A shows a schematic diagram of the user interface showing all the files across the various content sources sorted by times received/shared;

FIG. 9B illustrates a user interface showing content items ordered in accordance with some embodiments;

FIG. 10 illustrates a display that is shown when the content sources tab is selected by the user in some embodiments;

FIG. 11 shows two displays and that are generated in some embodiments;

FIG. 12 is an illustration of a user interface that enables tagging of content items in accordance with some embodiments;

FIG. 13 shows a user interface for sharing a plurality of content items in accordance with some embodiments;

FIG. 14 illustrates the displays that are respectively generated in accordance with some embodiments;

FIG. 15 illustrates internal architecture of a computing device in accordance with embodiments described herein; and

FIG. 16 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Embodiments are described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As technology evolves to produce better quality content, the need for content storage space increased exponentially. In addition to personal storage devices such as external hard drives, flash drives or data storage on computing devices like smartphones and laptops, third-party cloud storage services such as Dropbox and Google Docs have emerged to address the content storage needs of users. Third-party cloud storage providers offer services related to offsite storage of data for enterprise and individual users. While such myriad devices and services enhance a user's ability to receive and store data, having data stored at various locations can be very frustrating to a user who may be looking for a particular content item or when the user wants to share a content item with contacts. Currently there is no way that a user can share a content item on a third-party cloud storage with another user, without the other user also being a member of the same third-party cloud storage service or without making the content item public. This problem can be further exacerbated if the user wants to share content from multiple content sources which can include both personal devices and one or more third-party cloud storage services. Moreover, collecting and aggregating related data from the various content sources can be very difficult. For example, photos and/or videos related to an event can be stored and shared by the various attendees as attachments in their emails, posts on blogs or social-networking sites, online photo sites like Flickr or third-party storage services like Google Docs or Dropbox. Aggregating such far-flung data to create an information source that comprehensively covers the event can be a laborious, time-consuming task.

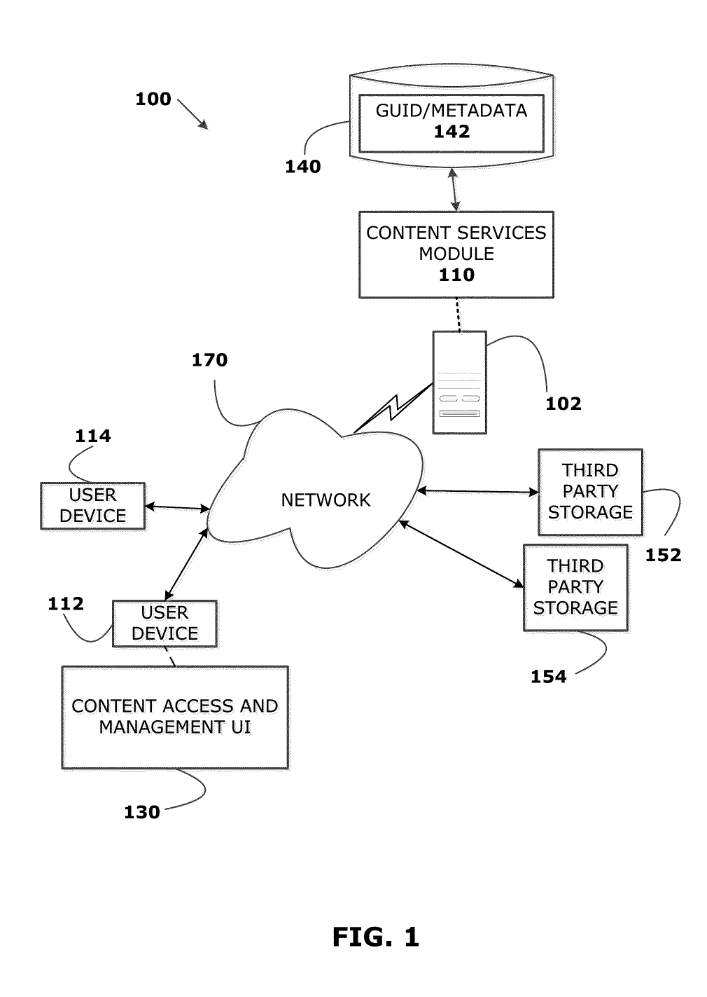

Embodiments disclosed herein relate to centralized data management systems and automated methods that simplify user access to multiple content sources. Turning now to the figures, FIG. 1 is a schematic diagram of a system 100 that provides centralized, ubiquitous content access and management for users in accordance with some embodiments. If a user has content stored in multiple user computing devices 112, 114 and with one or more of the third party storage servers 152, 154 the user can employ the content services module 110 for ubiquitous centralized management of all the content sources. In some embodiments, the devices 112, 114 can comprise but are not limited to a laptop, desktop, smartphone, imaging devices or wearable computing devices. Third party storage services can comprise storage servers 152, 154 accessible to the user devices 112, 114, 116 via the network 170 such as the Internet. In some embodiments, third-party storage servers can comprise but are not limited to email servers, social network servers, servers hosting blogs, instant messaging servers, online photo site servers

In some embodiments, the content services module 110 can be comprise program code or logic executed by the content services server 102. When a user initially connects to the content services server 102 via one of the user devices, for example, the user device 112, a content services UI (user interface) 130 is provided to the user. The content services UI 130 enables the user to access various functions provided by the content services module 110. During the registration process, the user can provide information regarding the user devices 112, 114 via the user interface 130 to the content services module 110 so that the content services module 110 can connect to the user devices 112, 114 and access the content stored on them.

Similarly the user interface 130 facilitates the user providing information regarding the third-party cloud services 152, 154 to the content services module 110. Based for example on the type of device employed by the user interface 130 for initial access, the user interface 130 can comprise a browser-based interface or an interface associated with an app downloaded by the user into a mobile computing device such as a smartphone. While only two user devices and two third party services are represented herein for brevity, it may be appreciated that the user can register any number of user devices and third-party storage services in accordance with embodiments described herein. In some embodiments, the content services UI 130 enables the user to provide information comprising respective account credentials for the third-party storage servers 152, 154. In some embodiments, the content services module 110 can go through OAuth flow to get and store the user's access token/account credentials. The content services module 110 uses these credentials and therefore can access user's content stored with the third-party storage servers 152, 154.

In some embodiments, the content services module 110 accesses and stores on a processor-readable storage medium 140 metadata of the content stored in the personal storage devices 112, 114 and the third-party content storage servers 152, 154. The content services module 110 can store content from the user devices 112, 114 and store the metadata index of the content from the third-party servers 152, 154. Each content item of the user from each of the content sources 112, 114, 152 and 154 is identified by the content services module 110 via a unique id. In some embodiments, the unique id can comprise a key-value pair wherein the key is “GUID:originalId” wherein the “GUID” is the Globally Unique Identifier provided to identify the user within the content services module 110. The originalId can be the identifier of the content on the third-party service. The value can comprise the metadata of the content such as but not limited to size, mime-type etc. In some embodiments, the value can be a json object. In some embodiments, the content item metadata can comprise a record in a database on the storage 140 wherein the key “GUID:originalId” can be an identifier for that record.

The GUID/metadata 142 thus generated and stored enables the central access and management of content associated with the content services module 110 described herein. Various functions such as accessing content across the various content sources comprising the user devices 112, 114 and third party storage servers 152, 154; ubiquitous search across the various content sources; flexible global tagging mechanism; flexible view filters applicable across the content sources; and user preference determinations are enabled by the content services module 110 in accordance with embodiments detailed herein.

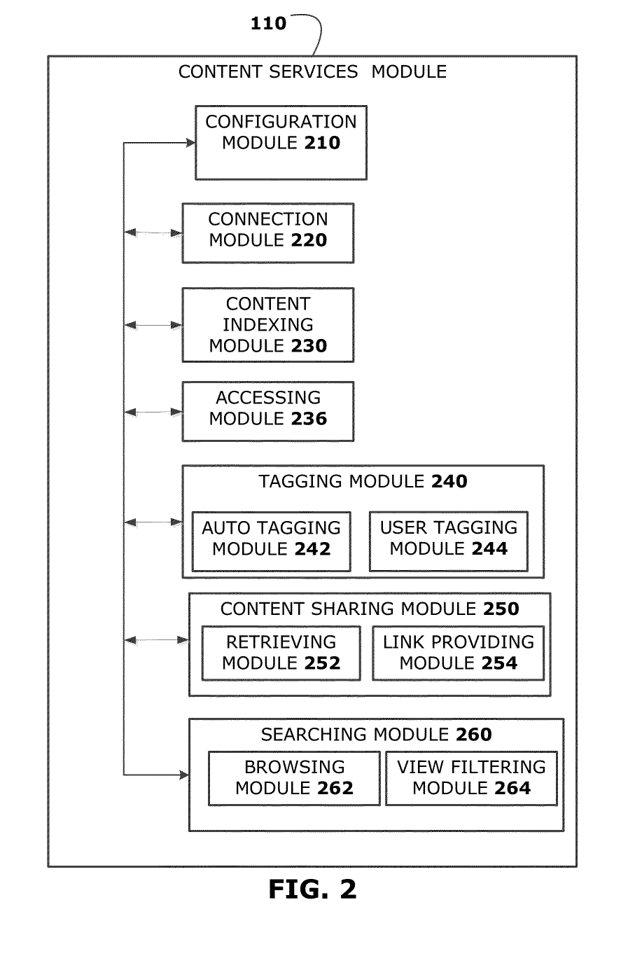

FIG. 2 is illustrates a detailed block diagram of the content services module 110 in accordance with some embodiments. The content services module 110 comprises a configuration module 202, a content indexing module 204, a tagging module 206, a search module 208 and a filter module 210. An initial user request for service is received by the configuration module 202. The configuration module 202 generates and/or assigns the GUID that uniquely identifies the user within the content services module 110. During the sign up process, the configuration module 202 also receives via the user interface 130 information regarding the various content sources 112, 114, 152, 154 that the user desires to link to the user's account on the content services module 110. The configuration module 210 also receives the user's credentials for connecting to the third-party content servers 152, 154. The information regarding the content sources along with the user's credentials for the third-party content sources 152, 154 is transmitted to the connection module 220. The credentials can comprise the user's identification indicia associated with each of the third-party storage services such as the user-name and password. The connection module 220 employs the received information to connect to the devices 112, 114 and the third party content servers 152, 154. It may be appreciated that different third-party content servers 152, 154 may have their respective modalities for connections not only because they are owned by different entities but also because they form a non-homogenous group of content sources. For example, the interface the connection module 220 employs for connecting to an email data source can be different from the interface used for connecting to an online photo service or a cloud data storage. Accordingly, based on the information supplied by the user, the connection module 220 can employ various interfaces and/or interface elements for connecting to the different content sources.

The content indexing module 230 accesses the metadata regarding the content items on the various content sources. The metadata associated with a content item can comprise but is not limited to content identification such as the file name, file size, content type, any user generated metadata such as tags or other metadata that may be specific to the content type. The received metadata is stored in the processor-executable storage 140 in an indexed manner. Moreover, as discussed supra, each content item is uniquely identified by a local identifier “GUID:originalID” wherein the GUID is the identifier of the user and the original ID identifies the content on the content source, for example, one of the third-party content servers 152 or 154. The stored metadata enables the user to execute various content management tasks. In some embodiments, the configuration module 210 can receive the content locally stored on the devices 112, 114 which is indexed and stored for user access by the content indexing module 230.

Access to the content items whose metadata is recorded by the content indexing module 230 is facilitated by the accessing module 236. In some embodiments, the accessing module 236 provides thumbnail images of the content items on the user interface 130. When the user clicks or otherwise selects the thumbnail, the content source is identified via the originalid of the selected content item. The content source is accessed to download and store a copy of the content item to the storage 140 by the accessing module 236. In some embodiments, the storage 140 can be a local storage in which the content services module 110 can have unrestricted access to read, write, delete or otherwise modify the data. The downloaded copy of the content item is made available to the user by the accessing module 236. If the content item is a shared content item, then the copy of the content item is provided to the user within the permissible time limits set by the owner of the content item. If the user is the owner of the content item, then the user is permitted to alter the local copy of the content item downloaded to the server 102 in accordance with some embodiments. In some embodiments, the changes may not be propagated back to the original content item located on the content source.

One of the tasks that is automated by the content servicing module 110 is global tagging of content across the various content sources. In some embodiments, the tagging module 240 further comprises an auto tagging module 242 for automatically tagging content accessed by the user via the content services module 110. The tagging module 240 further comprises a user tagging module 244 that provides a global tagging mechanism for the user to simultaneously tag a plurality of content items selected across a plurality of content sources with the same tag.

When a copy of a user-selected content item is downloaded by the server 102, the content item is scanned and the content therein is indexed by the auto tagging module 242. Various content items such as text, image, audio or video content items can be scanned by the auto tagging module 242. Based on the information obtained from scanning the content item, the content item is automatically tagged. For example, if the content item is a document, the tags can be extracted from the text therein. Similarly, if the content item is an image, it may be tagged with the entities therein. In addition, various metadata associated with the original content item file such as location data, date/time tags can also be recognized and stored by the auto-tagging module 242. Auto-tagging of the content items enables tasks such as searching and/or generated filtered views in accordance with embodiments described therein

Downloading and storing copies of the user-selected content items enables users to tag content items across the content sources. As the content items selected by the user are local copies on the server 102 to the content services module 110, changes made by the user to the content items such as the tags added by the user can be stored locally along with the content item metadata in the storage 140. For example, when a user receives audio, video and text content related to an event via myriad sources which can comprise but are not limited to email, SMS, links from photo-sharing sites or third-party cloud storage services, such items can be provided to the content services module 110. The content can be automatically tagged and stored by the content services module 110. Hence, when the user searches for the content the relevant content can be retrieved and the user further is enabled to add his/her own tags to such items. In some embodiments, the tags are only stored on the storage 140 without affecting the original files on the third-party storage servers 152, 154. In some embodiments, the tags can be uploaded to the content sources via synchronizing the app stream.

The content sharing module 250 enables users to share content indexed and stored by the content services module 110 without requiring them to be registered with any of the services providing the original content items or without having to make the content public. The retrieving module 252 comprised within the content sharing module 250 receives the user's input to share the content item in addition to the information regarding the content item to be shared. In some embodiments, the retrieving module 252 may check to determine if the content item(s) are stored within the storage 140 or within one of the external personal/third-party content sources.

When the content items are located, the link providing module 254 generates a local identifier comprising a key-value pair for each content item that the user desires to share and each recipient of the content item. The key in the key-value pair comprises “GUID_recipient:originalId” wherein the GUID_recipient is the user id of a recipient and originalId is the identification indicia of the content item on the third-party cloud storage service. In some embodiments, the value is a json object of the shared content item's metadata, such as a property “ownerId” with value comprising the GUID of the owner of the content item who in this use case would be the person sharing the content item. A communication comprising a link to the content item is transmitted by the link providing module 254 via a service such as but not limited to an email message, a SMS, a message via a social networking service and the like. When the recipient receives the message and wants to download the content, he/she clicks or otherwise activates the link. Upon the recipients activation of the link, the retrieving module 252 looks up the record “GUID_recipient:originalId” to determine the owner. Then the retrieving module 252 gets the user's (sender's) access credentials from the storage 140. The content item is then downloaded by the retrieving module 252 from one of the third-party servers 152, 154 to the storage 140 by employing the user's access credentials and streams the content back to the recipient. The content services module 110 therefore acts as a proxy, or proxies for the user when retrieving information with the content sources. In some embodiments, the content sharing module 250 also enables the user to stop sharing the content item. When the user wants to stop sharing the content item, the content services module 110 removes the key-value pair “GUID_recipient:originalId” from the storage 140 and the recipient will no longer have access to the shared content item.

The searching module 260 of the content services module 110 enables users, via an automated interface on a device, to browse for and/or search for content items across the various content sources such as but not limited to user computing devices 112, 114 and with one or more of the third party storage servers 152, 154. The browsing module 262 enables the user to browse through the content on the different sources and/or search for particular content items/type in the various content sources. The view filtering module 264 enables the user to generate views based on particular criteria input by the user via the user interface 130 in accordance with embodiments detailed further infra. In some embodiments, default view filtering criteria can be applied. For example, view filtering module 264 can implement a timeline wherein the content items can be presented to the user arranged in accordance with their respective temporal data.

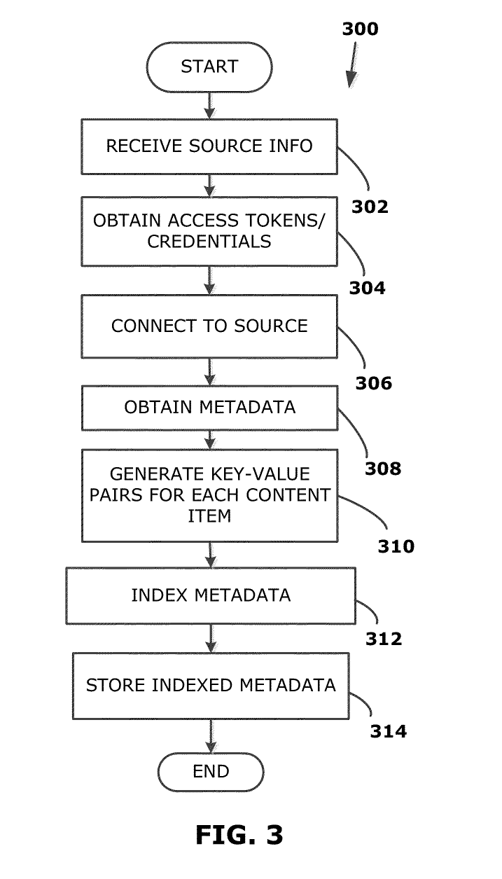

FIG. 3 is a flowchart 300 that illustrates a method of accessing content stored on a plurality of content sources in accordance with some embodiments. The method begins at 302 wherein the information regarding the various content sources from which information regarding the content items is to be stored is received from the user who initially requests access to services from the content services module 110. In some embodiments, if the content sources are the user's personal computing devices 112, 114, the content items can be directly backed up by the content services module 110. However, if the content sources are servers 152, 154 associated with third-party content storage services, and then the user's access tokens or credentials are received by the content services module 110 at 304.

As described supra, the content services module 110 acts as a proxy on the user's behalf to request access to content stored on the third-party storage servers 152, 154 using the credentials supplied by the user at 306. The metadata of the various content items stored at the plurality of third-party cloud storage servers 152, 154 is obtained at 308. The metadata of the content items can comprise but is not limited to, the size of the content item, the type of the content item or other item specific metadata. At 310, each content item accessed from the servers 152, 154 of the third-party cloud storage services is represented in the content services module 110 via a key-value pair. The key comprises the id of the user within the content services module 110. In some embodiments, the key can be of the form “GUID:originalID” wherein the GUID is the identifier of the user within the content services module 110 and the original ID identifies the content on the content source, for example, one of the third-party content servers 152 or 154. The value can be a json object including the content item metadata in accordance with some embodiments. The received metadata can be indexed at 312 so that when the user desires to retrieve a particular content item, the index can be accessed by the content services module 110 to speed up the retrieval process. The metadata thus obtained and indexed is stored at 314. Thus, the content services module 110 enables a user to access content stored across a plurality of content sources.

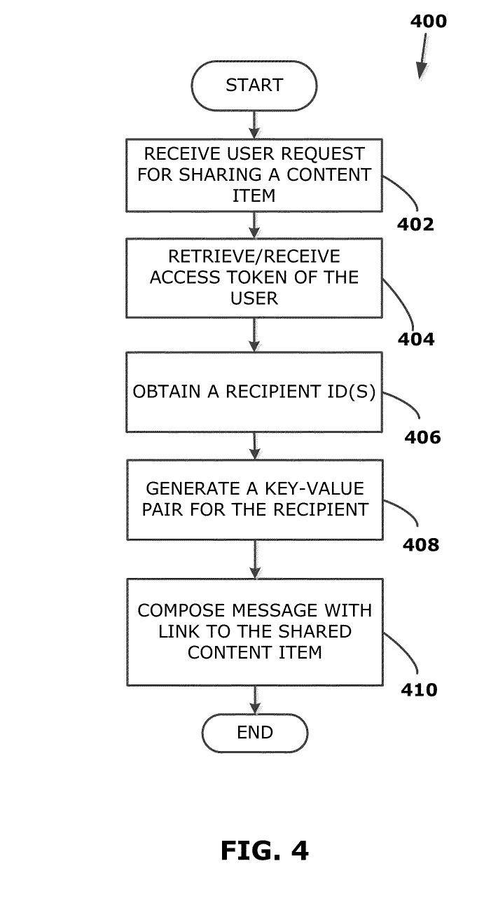

FIG. 4 is a flowchart 400 that details a method of enabling a user to share content items stored in a third-partly cloud storage in accordance with some embodiments. The method begins at 402 wherein a user request to share the content item is received. The request can be received in accordance with some embodiments when the user selects one or more content items to be shared with one or more recipients. In some embodiments, a single content item can be selected by the user to be shared with a plurality of recipients. In some embodiments, multiple content items can be selected by the user to be shared with a single recipient. Based on the user request/selections, the user access tokens or credentials for the various third-party content sources of the selected content items are obtained at 404. The recipient id information is obtained at 406. In some embodiments, the recipient(s) may or may not be members of the content services module 110. Accordingly, the recipient id information can be for example, the user id of the recipient within the content services module 110.

In some embodiments, if the recipients are not members of the content services module 110, the recipient id information can be, for example, the recipient's email address. At 408, the key-value pair(s) are generated for the content items selected for sharing by the user. If a single item is selected for sharing with multiple users a subset of whom may be members associated with the content servicing module 110 and another subset may be non-members. A plurality of key-value pairs can be generated corresponding to each user and the content item. For example, a plurality of key-value pairs when the key is of the form “GUID_recipient:originalId” wherein the GUID_recipient is the user id of each of the recipients and originalId is the identification indicia of the shared content item on the third-party cloud storage service. The value can be a json object comprising the metadata of shared content item and further comprising ownership information of the content item. In some embodiments, the owner of the content item can be the user sharing the content item.

Similarly, a plurality of key-value pairs can be generated if the user selects to share a plurality of content items stored across a plurality of third-party cloud storage services with a single recipient. In this case, the “GUID_recipient” portion of the key may be the same for all content items whereas the “originalId” part of the key varies for each of the plurality of content items to be shared. Moreover, the values comprising the json objects which include the respective metadata of the content items can also vary for each of the content items. In some embodiments, the key-value pair can be a record in a database on the storage 140 wherein the local identifier for each combination of the shared content item and the recipient can be the record identifier. At 410, a message comprising a link to the content item is transmitted to the recipient(s) for access to the shared content item(s).

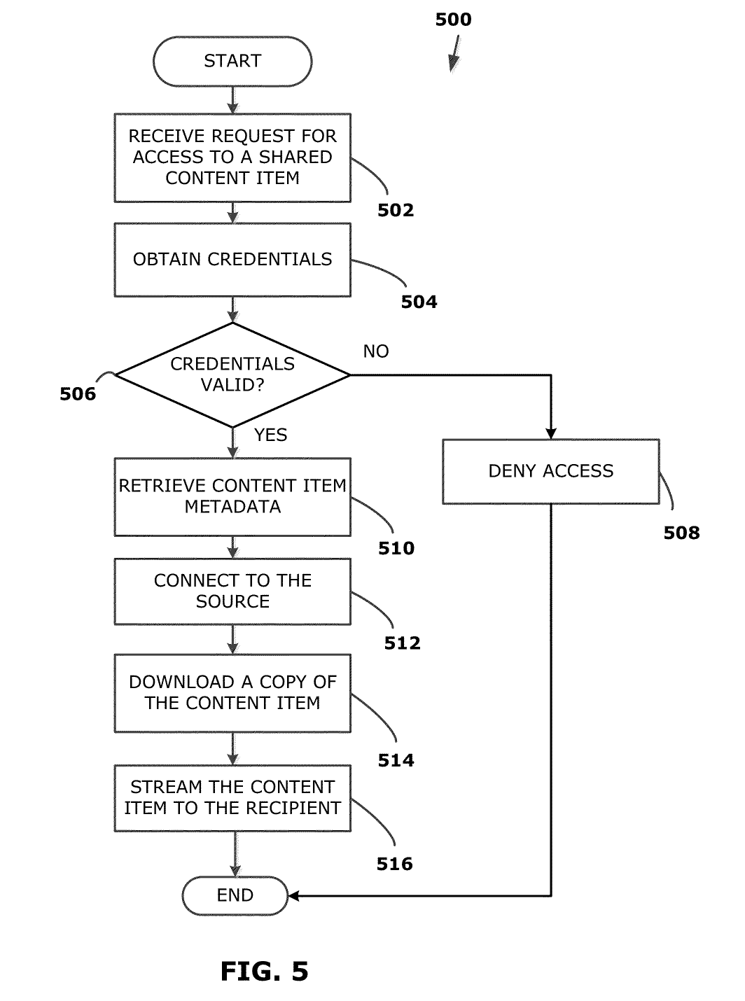

FIG. 5 is a flowchart 500 that details a method of providing a shared content item in accordance with some embodiments. The method begins at 502 wherein a request for access to a shared content item is received from a recipient. In some embodiments, the request can comprise an activation of a link in a message transmitted to the recipient. The credentials associated with the request are obtained at 504. By the way of illustration and not limitation, the credentials can comprise a local identifier associated with the recipient-content item combination. It may be checked at 506 if the local identifier associated with the link exists in the storage 140 of the content services module 110. For example, if a user who shares a content item with a recipient later deletes the local identifier associated with the recipient/shared item, the recipient may no longer be able to access the item upon the deletion. If the check fails at 506, the access to the content item is denied to the recipient at 508 and the method terminates. If the local identifier exists in the storage 140 it may be determined at 506 that the credentials are valid. The content item metadata is retrieved at 510. In some embodiments, the content item metadata can comprise a record in a database on the storage 140 retrieved via the local identifier. Based at least on the metadata of the content item, the source can be identified. At 512, the content services module 110 connects to the source and the content item is downloaded from the source at 514. The downloaded content item is streamed to the recipient at 516.

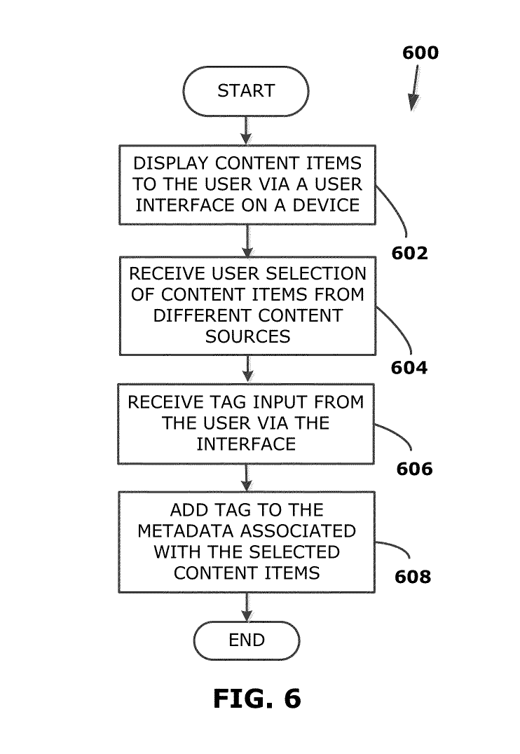

FIG. 6 is a flowchart 600 that details a method of tagging content items stored in different content sources in accordance with some embodiments. The method begins at 602, wherein a plurality of content items stored in various content sources comprising a user's personal computing devices as well as servers associated with a plurality of third-party cloud storage services are displayed via a user interface 130 on a selected personal computing device 112. For example, the display at 602 may have been generated in response to a user's search query for content items across the plurality of content sources. At 604, the user selection of at least a subset of the displayed content items is received by the user tagging module 244. At 606, the tag input to be applied to the selected content items is received from the user. The received tag input is applied to the selected content items at 608. In some embodiments, the tag input can be added to the content item metadata in the storage 140. Thus, a user can simultaneously tag a plurality of content items stored in different content sources such as one or more personal devices, email accounts, third-party cloud storage services and the like via the global tagging facilitated by the content services module 110 and accessed via a single user interface or app on a device. When the user at a later time attempts to locate related content items scattered across a plurality of content sources, he or she may conveniently look for or search for the tag in order to be presented with a view of the related content items stored in different content sources.

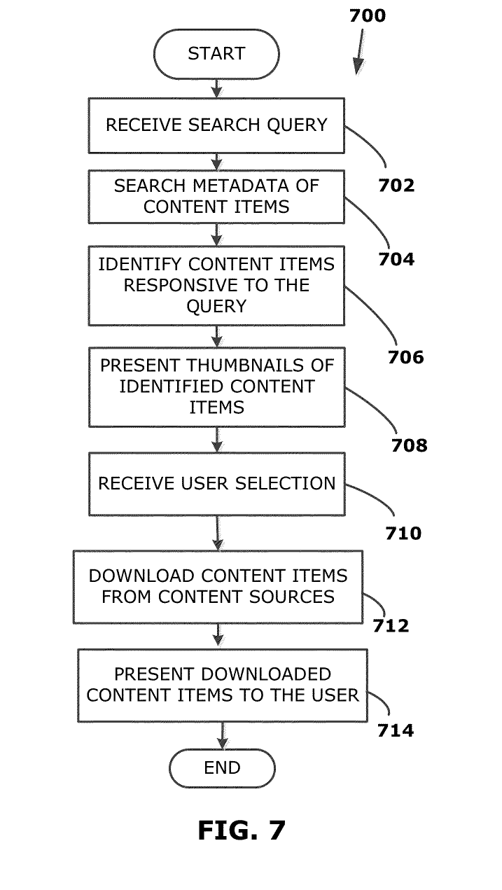

FIG. 7 is a flowchart 700 that details a method of searching for content items across a plurality of content sources in accordance with some embodiments. The method begins at 702 wherein a query is received from the user for content items matching particular criteria. Various search criteria such as but not limited to locations, time, entities, file types, sizes and the like can be received. At 704, the metadata of the content items in the storage 140 is searched in response to the query. At 706, content items related to the query criteria are identified. The criteria can comprise but are not limited to text matching, temporal criteria matching, entities included in the items that are related to the search criteria and the like can be employed at 706.

Moreover, it may be appreciated that as the metadata index comprises metadata about content items stored on the plurality of content sources such as personal computing devices 112, 114, third-party cloud servers 152, 154, hence, the content items identified at 706 would comprise content items from such various content sources. The thumbnail representations of the items identified at 706 are shown to the user at 708. In some embodiments the thumbnails presented at 708 can be user selectable. At 710 the user selection of thumbnails are received and the content items corresponding to the user-selected content items are downloaded from their respective content sources at 712. The downloaded content items are provided to the user at 714 when the user selects to view the content item. Downloading of the content items for presentation to the user enables the content services module 110 to provide various functions such as global tagging, sharing content items with users who may not be subscribers of the third-party cloud storage and searching across the content items in the various cloud storage services.

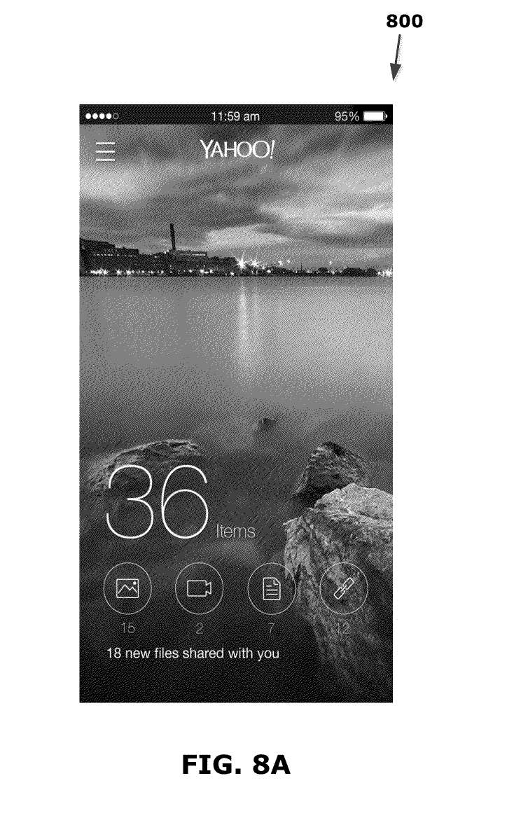

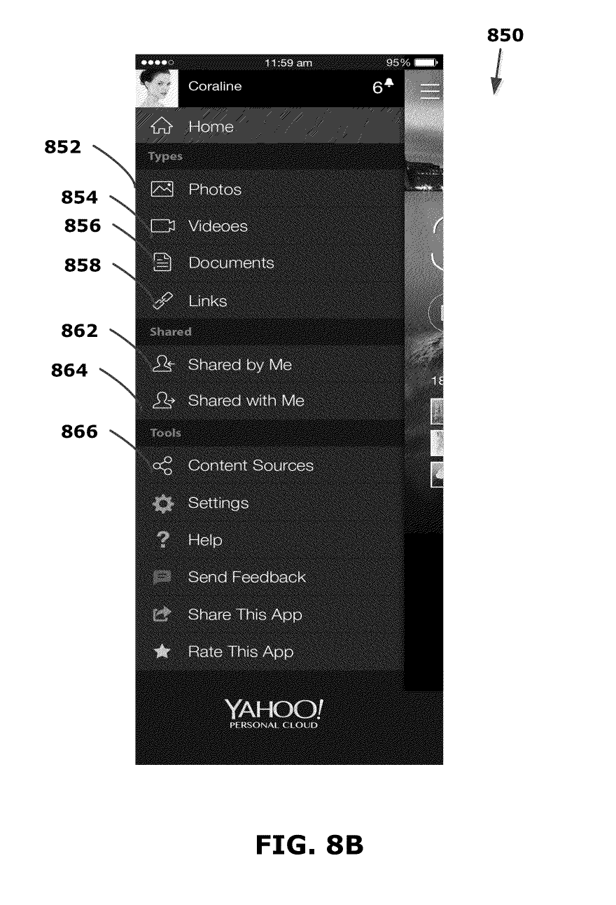

FIG. 8A shows a schematic diagram 800 of a cover page of the content access and management user interface 130 in accordance with some embodiments. It indicates to the user that 36 items are stored of which there are 15 images 2 videos, 7 documents, 12 links and that 18 new items were shared with the user.

FIG. 8B is a schematic diagram of a sidebar that is part of the content access and management user interface 130 in accordance with some embodiments. The sidebar provides access to the content items across the plurality of content sources based on the content types. For example, the content items are grouped by photos 852, videos 854, documents 856 and links 858. In addition, content items can also be grouped as “shared by me” 862 and “shared with me” 864. The content items from the plurality of content sources shared by the user with other users can be accessed via “shared by me” 862 tab. The content items shared by other with the user can be accessed via the “shared with me” 864 tab. In addition, the content items tab 866 provides user the access to the various content sources provisioned for the user by the content services module 110. In some embodiments, the content sources tab 866 can enable to the user to add or delete the content sources.

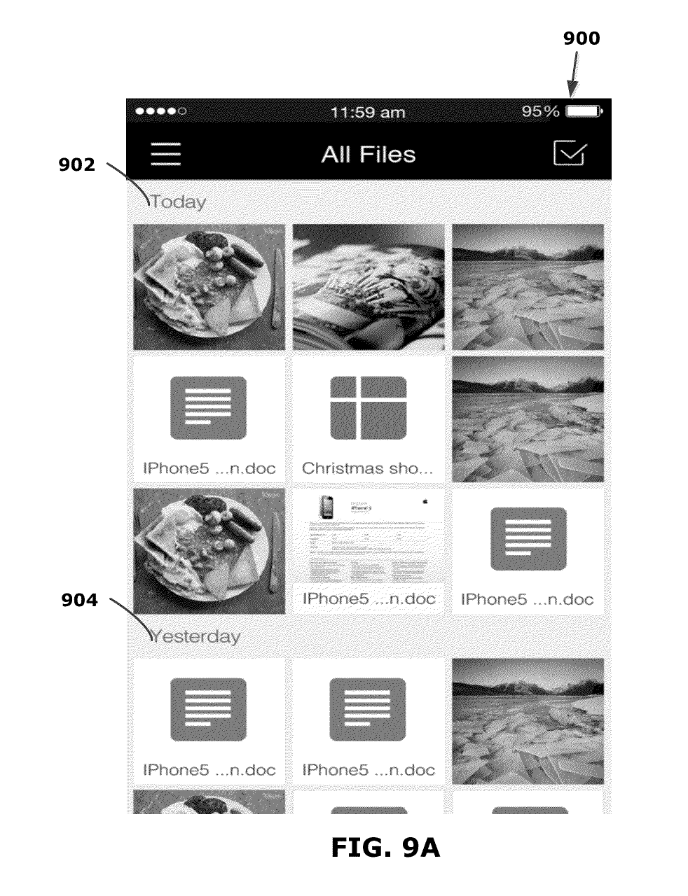

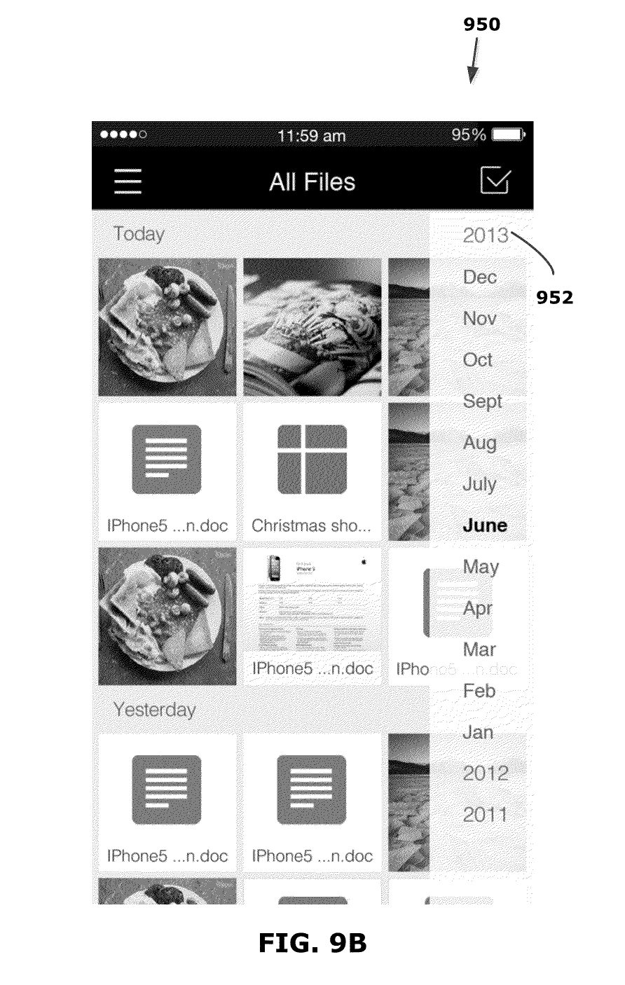

FIG. 9A shows a schematic diagram 900 of an example of the user interface showing all the files across the various content sources sorted by times received/shared. The content items shown at 902 are items that were shared or received by the user today whereas the content items shown under the tab 904 are the content items shown yesterday. The content items comprise a mixture of types wherein the photos, documents, spreadsheets and the various types of items received on that day are displayed. FIG. 9B illustrates a user interface 950 showing content items ordered in accordance with the timeline 952.

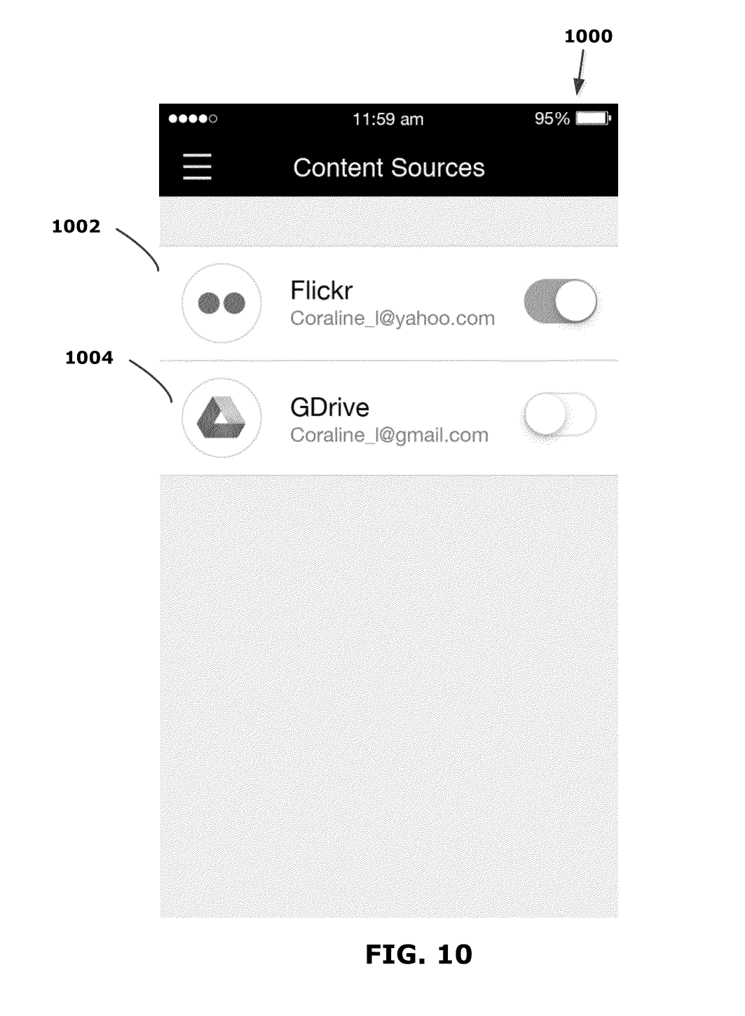

FIG. 10 illustrates a display 1000 that is shown when the content sources tab 866 is selected by the user. The content sources connected to the user's account with the content services module 110 are listed under this tab in accordance with some embodiments. In some embodiments, the content sources linked to the user's profile can be accessed via the ‘content sources’ tab 866. Two content sources are listed wherein the first content source, Flickr 1002 is an online photo sharing website while the second content source 1004 is the GDrive which is a third-party cloud storage service. It may be appreciated that while only third-party content sources are shown for brevity, this is not necessary. More or less number of content sources including the user's personal computing devices may also be accessed from the content sources tab.

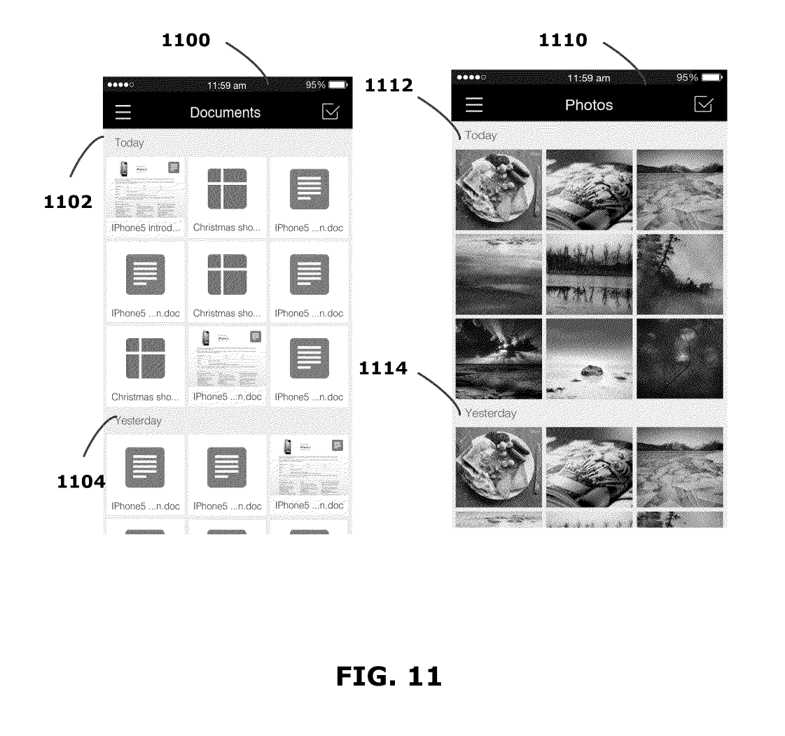

FIG. 11 shows two displays 1100 and 1110 that are generated respectively when the documents tab 856 or the photos tab 852 is selected by the user. The displays 1100, 1110 are sorted by the days so that the display 1100 shows only documents type of content that the user may have sent or received on each day at 1102 and 1104. Similarly, 1110 shows the photos that the user may have interacted with (sent or received) on each day at 1112 and 1114. It can be appreciated that the photos and documents shown respectively in the views 1110 and 1100 may be stored on different content sources listed under the content sources tab 866 or a subset of the displayed photos and/or documents may have been downloaded from the content sources 112, 114, 152 or 154 to the storage 140 by the content services module 110.

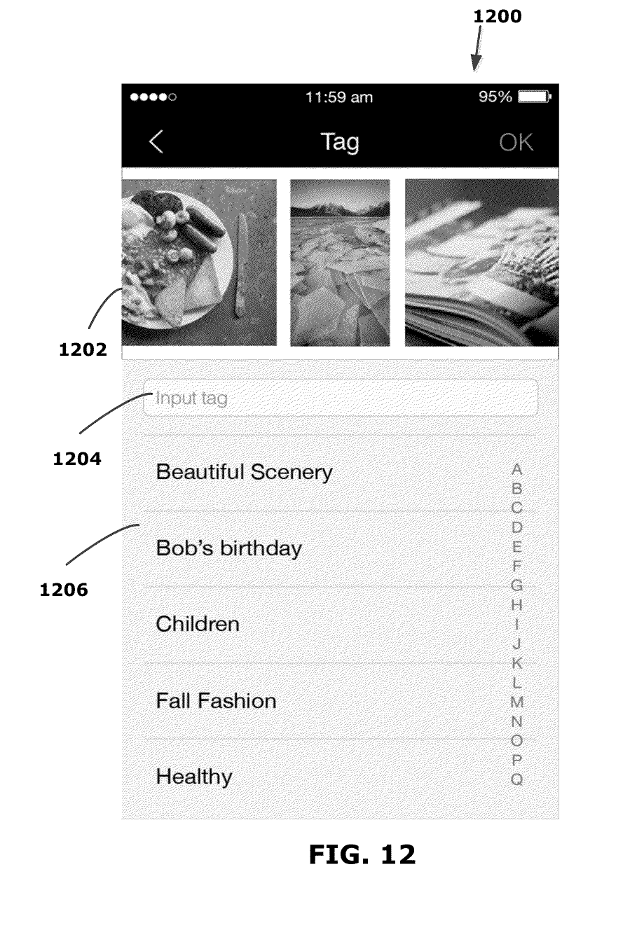

FIG. 12 is an illustration of a user interface 1200 that enables tagging of content items in accordance with some embodiments. A plurality of content items 1202 from downloaded from one or more of the various content sources 112, 114, 152 or 154 are displayed. A user interface element such as a textbox 1204 for inputting a tag for the plurality of content items 1202 is also shown. The user therefore is able to apply a common tag simultaneously to plurality of content items 1202. A listing of currently tagged 1206 content items is also included in the user interface 1200. Some of the content items in the listing 1206 may have been automatically tagged by the auto tagging module 242. The content services module 110 thus enables global tagging of content items from across the various content sources.

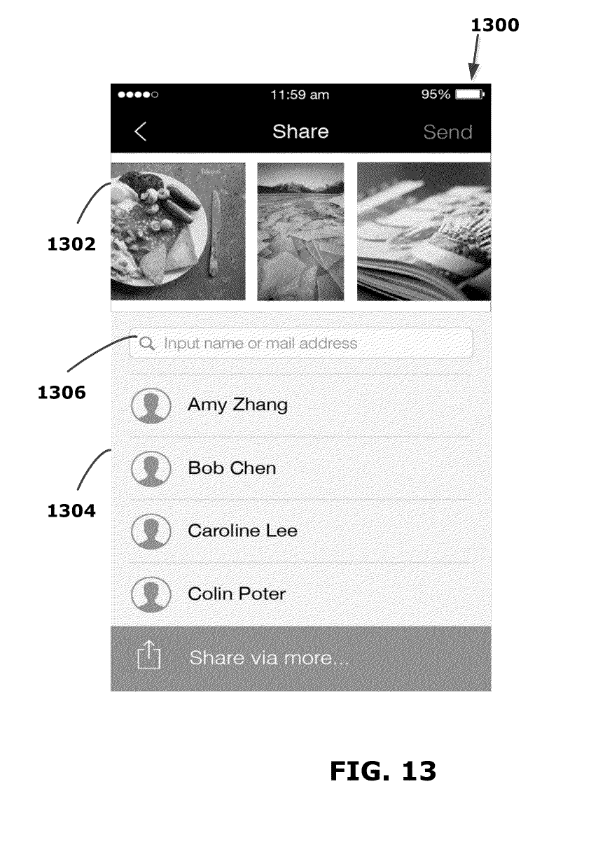

FIG. 13 shows a user interface 1300 for sharing a plurality of content items 1302 in accordance with some embodiments. One or more of the content items 1302 can be selected for sharing with one or more contacts 1304. A user interface element 1306 is provided for entering information regarding the selected contacts. If the content items 1302 are stored across a plurality of content sources, the content services module 110 obtains the sharing user's access tokens for those content sources that require security credentials to be presented. The content services module 110 employs the security credentials to proxy as the user to such content sources. Upon the user's access tokens being cleared by the content sources, local identifiers are generated for the content items/contacts the user selects to share. Communications comprising links to the shared content items are transmitted to the user-selected contacts in accordance with embodiments detailed herein.

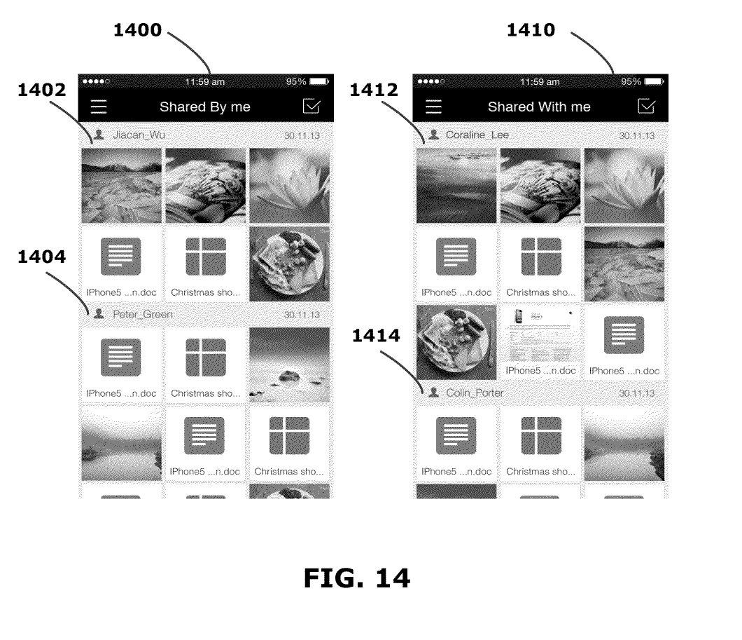

FIG. 14 illustrates the displays 1400 and 1410 that are respectively generated when a user selects the “shared by me” 862 and “shared with me” 864 tabs in accordance with some embodiments. The displays 1400 and 1410 include various types of content items that were respectively shared with different contacts. All the content items that the user selects to share with other users is shown in the display 1400. The content items in the display 1400 are ordered in accordance with the different contacts 1402, 1404 with whom the user selected to share content items. Similarly, content items in the display 1410 are ordered in accordance with different contacts 1412, 1414 who shared their content with the user.

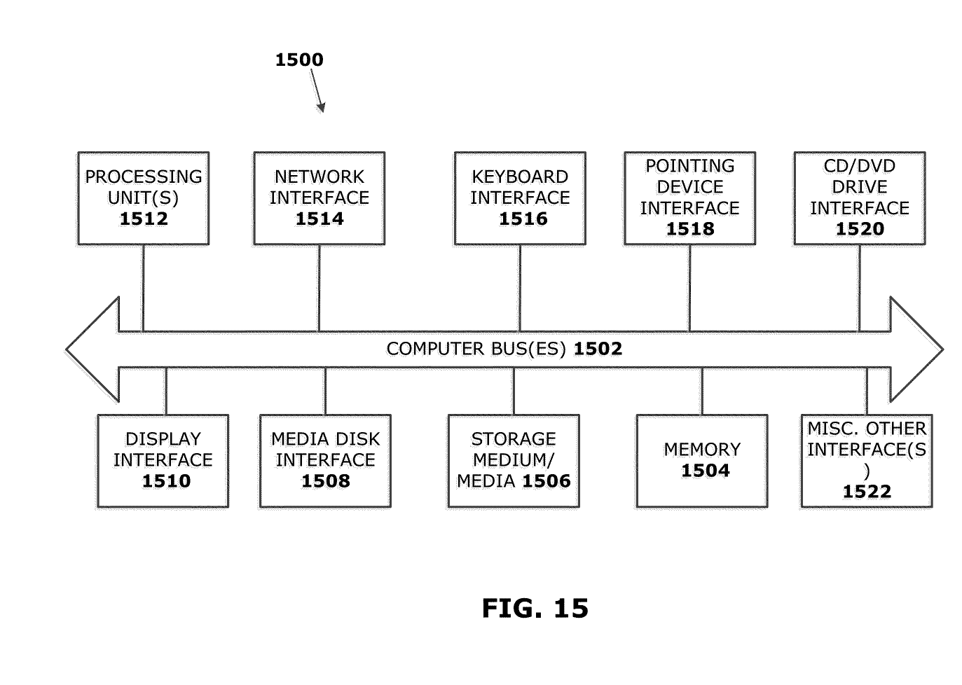

FIG. 15 is a schematic diagram that shows the internal architecture of a computing device 1500 that can be used, for example, as the server 102 for hosting the content services module 110 in accordance with some embodiments. As shown in the example of FIG. 15, the internal architecture of the computing device 1500 includes one or more processing units (also referred to herein as CPUs) 1512, which interface with at least one computer bus 1502. Also interfacing with computer bus 1502 are persistent storage medium/media 1506, network interface 1514, memory 1504, e.g., random access memory (RAM), run-time transient memory, read only memory (ROM), etc., media disk drive interface 15015, an interface 1520 for a drive that can read and/or write to media including removable media such as floppy, CD-ROM, DVD, etc., media, display interface 1510 as interface for a monitor or other display device, keyboard interface 1516 as interface for a keyboard, pointing device interface 15115 as an interface for a mouse or other pointing device, and miscellaneous other interfaces 1522 not shown individually, such as parallel and serial port interfaces, a universal serial bus (USB) interface, and the like.

Memory 1504 interfaces with computer bus 1502 so as to provide information stored in memory 1504 to CPU 1512 during execution of software programs such as an operating system, application programs, device drivers, and software modules that comprise program code or logic, and/or computer-executable process steps, incorporating functionality described herein, e.g., one or more of process flows described herein. CPU 1512 first loads computer-executable process steps or logic from storage, e.g., memory 1504, storage medium/media 1506, removable media drive, and/or other storage device. CPU 1512 can then execute the stored process steps in order to execute the loaded computer-executable process steps. Stored data, e.g., data stored by a storage device, can be accessed by CPU 1512 during the execution of computer-executable process steps.

Persistent storage medium/media 1506 is a computer readable storage medium(s) that can be used to store software and data, e.g., an operating system and one or more application programs. Persistent storage medium/media 1506 can also be used to store device drivers, such as one or more of a digital camera driver, monitor driver, printer driver, scanner driver, or other device drivers, web pages, content files, metadata, playlists and other files. Persistent storage medium/media 1506 can further include program modules/program logic in accordance with embodiments described herein and data files used to implement one or more embodiments of the present disclosure.

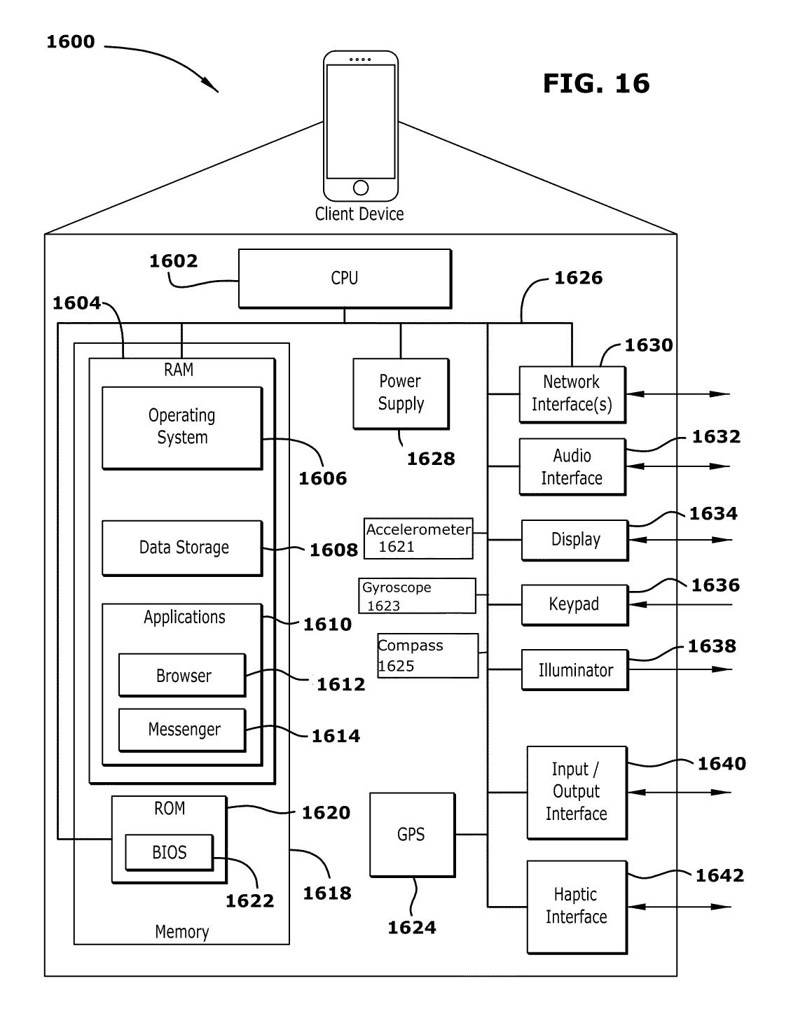

FIG. 16 is a schematic diagram illustrating a client device implementation of a computing device in accordance with embodiments of the present disclosure. For example, one or more of the content sources 112, 114 or a device that enables the ubiquitous, centralized content access and management in accordance with embodiments described herein can be implemented as a client device. A client device 1600 may include a computing device capable of sending or receiving signals, such as via a wired or a wireless network, and capable of running application software or “apps” 1610. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1602, power supply 1628, a memory 1618, ROM 1620, BIOS 1622, network interface(s) 1630, audio interface 1632, display 1634, keypad 1636, illuminator 1638, I/O interface 1640 interconnected via circuitry 1626. Claimed subject matter is intended to cover a wide range of potential variations. For example, the keypad 1636 of a cell phone may include a numeric keypad or a display 1634 of limited functionality, such as a monochrome liquid crystal display (LCD) for displaying text. In contrast, however, as another example, a web-enabled client device 1600 may include one or more physical or virtual keyboards 1636, mass storage, one or more accelerometers 1621, one or more gyroscopes 1623 and a compass 1625 global positioning system (GPS) 1624 or other location identifying type capability, Haptic interface 1642, or a display with a high degree of functionality, such as a touch-sensitive color 2D or 3D display, for example. The memory 1618 can include Random Access Memory 1604 including an area for data storage 1608.

A client device 1600 may include or may execute a variety of operating systems 1606, including a personal computer operating system, such as a Windows, iOS or Linux, or a mobile operating system, such as iOS, Android, or Windows Mobile, or the like. A client device 1600 may include or may execute a variety of possible applications 1616, such as a client software application 1614 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1600 may also include or execute an application to communicate content, such as, for example, textual content, multimedia content, or the like. A client device 1600 may also include or execute an application to perform a variety of possible tasks, such as browsing 1612, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server. Servers may vary widely in configuration or capabilities, but generally a server may include one or more central processing units and memory. A server may also include one or more additional mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), program logic, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1) A method comprising:
receiving, by a processor, a request from a first user to connect to a plurality of personal devices having stored thereon a plurality of local content items and to a plurality of third-party cloud storage services having stored thereon a plurality of third-party cloud storage content items;
receiving, by the processor, credentials of the first user for the third-party cloud storage services;
connecting, by the processor via a network, to the third-party cloud storage services using the credentials;
obtaining, by the processor, metadata of third-party cloud storage content items stored on the third-party cloud storage services;
storing, by the processor, the metadata on a processor readable storage medium; and
providing to the first user, by the processor, a user interface on a selected personal computing device that interfaces with the processor, and via user interaction with the user interface and via the metadata, enables access to the plurality of local content items and the plurality of third-party cloud storage content items.

2) The method of claim 1, the metadata of each of the third-party cloud storage content items comprises a key-value pair, the key comprising the first user's GUID (Globally Unique ID) and an originalID uniquely identifying the third-party cloud storage content item.

3) The method of claim 2, the value in the key-value pair comprises the metadata of the content item.

4) The method of claim 1, further comprising:
providing, by the processor, a user interface element that enables the first user to share at least one of the local content items and the third-party cloud storage content items;
receiving, by the processor, a request from the first user to share a third-party cloud storage content item stored with one of the third-party cloud storage services with at least one second user.

5) The method of claim 4, enabling sharing one of the third-party cloud storage content items further comprises:
generating, by the processor, a key-value pair for the second user, the key of the key-value pair of the second user further comprising the second user's GUID and an originalID uniquely identifying the shared third-party cloud storage content item.

6) The method of claim 5, the value in the key-value pair of the second user comprises the metadata of the content item that further comprises ownership information associated with the first user.

7) The method of claim 1, obtaining metadata of content items on the plurality of third-party cloud storage services further comprising:
fetching, by the processor, metadata of the plurality of content items via respective APIs (Application programming interface) of the plurality of third-party cloud services.

8) The method of claim 1, further comprising:
receiving from the selected personal computing device, by the processor, a request to access at least one of the third-party cloud storage content items.

9) The method of claim 8, further comprising:
accessing, by the processor, metadata of the at least one third-party cloud storage content item;
downloading, by the processor from a respective third-party cloud storage server, the at least one third-party cloud storage content item;
streaming, by the processor to the selected personal computing device, a downloaded copy of the at least one third-party cloud storage content item.

10) The method of claim 1, further comprising:
downloading, by the processor from respective third-party cloud storage servers, a plurality of the third-party cloud storage content items; and
storing, by the processor, copies the plurality of the cloud storage content items.

11) The method of claim 10, further comprising:
receiving, by the processor, at least one tag for commonly applying to each of the plurality of the cloud storage content items; and
storing, by the processor, the at least one tag with respective metadata of each of the plurality of the cloud storage content items.

12) An apparatus comprising:
a processor;
a non-transitory processor readable storage medium, the processor readable storage medium having stored thereon programming logic, the programming logic comprising:
request receiving logic, executed by the processor, for receiving a request from a first user to connect to a plurality of personal devices having stored thereon a plurality of local content items and to a plurality of third-party cloud storage services having stored thereon a plurality of cloud storage content items;
credential receiving logic, executed by the processor, for receiving credentials of the first user for the third-party cloud storage services;
connecting logic, executed by the processor, for connecting via a network to the third-party cloud storage services using the credentials;
metadata obtaining logic, executed by the processor, for obtaining metadata of third-party cloud storage content items stored on the third-party cloud storage services;
metadata storing logic, executed by the processor, for storing the metadata on a processor readable storage medium; and
interface providing logic, executed by the processor, for providing to the first user, a user interface that interfaces with the processor, and via user interaction with the user interface and via the metadata, enables access to the plurality of local content items and the third-party cloud storage content items.

13) The apparatus of claim 12, the metadata of each of the third-party cloud storage content items comprises a key-value pair, the key comprising the first user's GUID (Globally Unique ID) and an originalID uniquely identifying the third-party cloud storage content item.

14) The apparatus of claim 13, the value in the key-value pair comprises the metadata of the content item.

15) The apparatus of claim 12, the interface providing logic further comprising logic for:
providing a user interface element that enables the first user to share at least one of the local content items and the third-party cloud storage content items;
receiving a request from the first user to share a third-party cloud storage content item stored with one of the third-party cloud storage services with at least one second user.

16) The apparatus of claim 15, the programming logic for enabling sharing one of the third-party cloud storage content items further comprises programming logic for:
generating, by the processor, a key-value pair for the second user, the key of the key-value pair of the second user further comprising the second user's GUID and an originalID uniquely identifying the shared third-party cloud storage content item.

17) The apparatus of claim 16, the value in the key-value pair of the second user comprises the metadata of the content item that further comprises ownership information associated with the first user.

18) The apparatus of claim 12, further comprising programming logic for:
downloading from respective third-party cloud storage servers, a plurality of the third-party cloud storage content items;
storing copies the plurality of the cloud storage content items.

20) The apparatus of claim 18, further comprising programming logic for:
receiving at least one tag for commonly applying to each of the plurality of the cloud storage content items; and
storing the at least one tag with respective metadata of each of the plurality of the cloud storage content items.

21) A non-transitory computer readable storage medium, comprising processor-executable instructions for:
receiving a request from a first user to connect to a plurality of personal devices having stored thereon a plurality of local content items and to a plurality of third-party cloud storage services having stored thereon a plurality of third-party cloud storage content items;
receiving credentials of the first user for the third-party cloud storage services;
connecting via a network, to the third-party cloud storage services using the credentials;
obtaining metadata of third-party cloud storage content items stored on the third-party cloud storage services;
storing the metadata on a processor readable storage medium; and
providing to the first user, a user interface on a selected personal computing device that interfaces with the processor, and via user interaction with the user interface and via the metadata, enables access to the plurality of local content items and the plurality of third-party cloud storage content items.

22) The non-transitory computer readable storage medium of claim 21, the metadata of each of the third-party cloud storage content items comprises a key-value pair, the key comprising the first user's GUID (Globally Unique ID) and an originalID uniquely identifying the third-party cloud storage content item and the value in the key-value pair comprises the metadata of the content item.

23) The non-transitory computer-readable storage medium of claim 21 further comprising instructions for:
providing a user interface element that enables the first user to share at least one of the local content items and the third-party cloud storage content items;
receiving a request from the first user to share a third-party cloud storage content item stored with one of the third-party cloud storage services with at least one second user.

24) The non-transitory computer readable storage medium of claim 23 further comprising instructions for:
generating a key-value pair for the second user, the key of the key-value pair of the second user further comprising the second user's GUID and an originalID uniquely identifying the shared third-party cloud storage content item and the value in the key-value pair of the second user comprises the metadata of the content item that further comprises ownership information associated with the first user.

25) The non-transitory computer readable storage medium of claim 21, further comprising instructions for:
downloading from respective third-party cloud storage servers, a plurality of the third-party cloud storage content items;
storing copies the plurality of the cloud storage content items;
receiving at least one tag for commonly applying to each of the plurality of the cloud storage content items; and
storing the at least one tag with respective metadata of each of the plurality of the cloud storage content items.
